(19) United States
(12) Patent Application Publication
(10) Pub. No.: US 2009/0319948 A1
(43) Pub. Date: Dec. 24, 2009

(54) Automated editing of graphics charts

(75) Inventors: Paul Stannard, Rancho Santa Fe, CA (US); Joshua Platt, San Diego, CA (US)

Correspondence Address: TERRANCE A. MEADOR;INCAPLAW, 1050 ROSCRANS STREET, SUITE K, SAN DIEGO, CA, 92106, US

(73) Assignee: SmartDraw.com, San Diego, CA (US)

(21) Appl. No.: 12/214,665

(22) Filed: Jun. 20, 2008

(51) Int. Cl. G06T 11/20; G06F 3/048

(52) U.S. Cl. 715/810; 345/440

(57) ABSTRACT

Editing of a computer- or processor-generated graphics chart is enhanced by automatic movement of shapes and editing of lines in the chart when shapes are added to or deleted from the chart in response to user-entered commands.

### BACKGROUND

The field includes interactive graphics programs which automatically manage the editing of graphics charts generated by a computer or processor.

A computer or processor may be programmed or constructed to execute or perform an interactive graphics process in which a computer- or processor-generated graphics output is provided in response to commands entered by a user. The interactive graphics process may be embodied, for example, as a drawing program, as application-specific hardware, or a combination thereof. The graphics output is a visual representation of something conceived by the user. An important feature of an interactive graphics process is the capability of drawing graphics charts in response to user prompts and commands.

A graphics chart is a visible diagram, map, model, or schematic composed of objects (such as lines and symbols) arranged to represent relationships among events, conditions, units, process steps, and so on. The relationships may be functional, spatial, temporal, cause/effect, structural, organizational, physical, or any equivalent thereof in any combination thereof. Examples of graphics charts include, without limitation, flow charts, cause and effect diagrams, decision trees, mind maps, Gantt charts, device and system models, and so on.

A graphics chart has a format, that is to say, a defined set of rules about the structure of the diagram, map, model, or schematic being generated. For example, a flow chart is constituted of symbols representing steps of a process or an algorithm and lines which connect the symbols to show sequences in which the steps occur.

Annotation is frequently used to impart information in addition to that which may be inherent in visible non-verbal aspects of a graphics chart. For example, a diamond in a flow chart typically indicates a branch in a process or algorithm. Annotation in the diamond may be used to describe a test or decision underpinning the branch.

As a graphics chart is composed by a drawing program, it may be edited by addition, insertion, deletion, movement, and/or annotation of objects. Any one or more of these editing acts may give rise to the desirability, H not the need, to alter, modify, amend, or otherwise change the layout of the graphics chart within the constraints of a particular format. Additional steps that are typically taken to maintain the symmetry, continuity, and visual logic of an edited graphics chart during editing require user actions to enter additional commands to move and reorder shapes, delete lines, extend lines, and so on.

As a result, editing a graphics chart generated by a graphics process typically requires a level of sophistication or familiarity with the operation of a graphics process that may not be possessed or easily acquired by a typical user. Further, many editing tasks require multiple commands and actions that are directed to redrawing and reordering the elements of a graphics chart upon completion of an editing task. This makes operation of a graphics process time-consuming and complex for average users and tedious for sophisticated users. Consequently, many commercially-available drawing programs are significantly underutilized for graphics chart drawing tasks. Performance of a graphics process would be enhanced, and utilization increased in this regard by reduction in the time, complexity, and number of acts required of a user to edit graphics charts generated by the process.

### SUMMARY

Editing a computer- or processor-generated graphics chart is accompanied by automatically moving shapes and editing lines in the chart when shapes are added to or deleted from the chart in response to user-entered commands.

A computer- or processor-generated graphics chart is edited by automatically moving shapes and editing lines in the chart when user-initiated commands for adding or deleting objects to the chart are executed.

Editing of a computer- or processor-generated graphics chart is provided by automatically moving shapes and editing lines in the chart when commands for editing shapes are received.

Symmetry, continuity, and visual logic of a computer- or processor-generated graphics chart are maintained during editing of a computer- or processor-generated graphics chart by automatically moving shapes and editing lines when shapes are added to or deleted from the chart in response to commands.

### BRIEF DESCRIPTION OF THE DRAWINGS

FIG. 1 is a block diagram of a computer or processor system for automatically editing a graphics chart.

FIG. 2 is a flow chart illustrating a graphics process with provision for automatically editing a graphics chart when objects are added to or deleted from the chart.

FIG. 3 is a pictorial representation illustrating how a computer- or processor-implemented graphics process automatically edits a graphics chart by reordering shapes and editing lines when commands for adding, inserting, deleting, and/or moving shapes in the chart are received and executed.

FIGS. 4A-4I illustrate examples of automatic editing of a graphics chart.

FIG. 5 is a pictorial representation of a graphical user interface capable of being modified based on selection of a type of graphics chart.

FIGS. 6A-6C are pictorial representations of a graphical user interface with a command panel tailored for a graphics chart.

FIG. 7 is a pictorial representation of a graphics chart embodied as a cause and effect chart.

FIG. 8 is a pictorial representation of a graphics chart embodied as a decision tree.

### SPECIFICATION

A “graphics process” may refer to a graphics program, process, method, or equivalent, and a “graphics processor” to a programmed computer, special purpose processor, networked process, or equivalent. Use of the term “graphics process” alone to explain an example, an illustration, an embodiment, or a mode of use should be understood to also explain the example, illustration, embodiment, or mode of use with respect to a “graphics processor”, absent some indication to the contrary. The principles to be presented in this specification are applicable to computer- and/or processor-generated graphics charts. The specific examples used to illustrate these principles are not intended to, and should not, limit their scope to a particular kind of graphics chart.

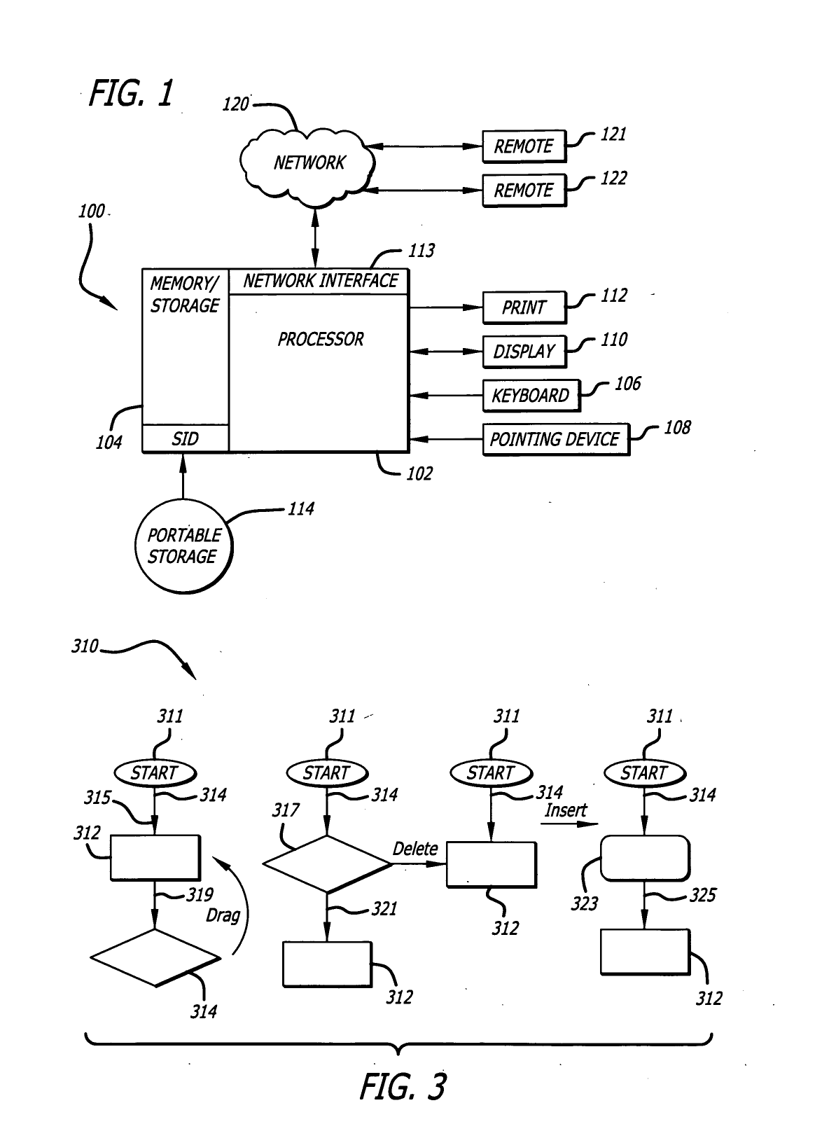

FIG. 1 illustrates an operational environment, and a computer system in which a graphics process may automatically edit graphics charts according to the principles explained below. The computer system 100 includes a programmed general or special purpose computer or processor 102 having memory and storage 104. The computer or processor 102 receives keystroke inputs from a keyboard or equivalent device 106 and receives other input from a manually-operated pointing device 108, such as a mouse. A display 110 provides a visual graphical user interface and a printer 112 generates printed output. A network interface 113 enables the computer system 100 to operate via a network 120, which may be local or global, with one or more remote entities 121, 122. The remote entities may be any one or more of other computers or processors, servers, websites, network nodes, and other equivalents. Graphics process programming may be stored, accessed, and executed solely at the computer system, or by way of a network to which the computer system 100 is connected. The computer or processor 102 may receive commands, including commands for editing graphics charts, generated by any one or more of keystrokes on the keyboard 106, drag-and-drop actions involving the pointing device 108 and the display 110, and point-and-click actions involving the pointing device 108 and the display 110. The computer or processor 102 generates visual output, including graphics charts, by display through the display device 110 and/or the printer 112.

In FIG. 1, the computer or processor 112 is enabled to execute a graphics process by programming received from a computer-readable storage medium which may be constituted of a portable storage device 114 such as a CD, DVD, memory stick, or other equivalent device, or by programming downloaded via network interface 113. So programmed, the computer or processor 102 constitutes a graphics processor and is enabled to practice a graphics process that generates and automatically edits graphics charts.

Editing of a computer- or processor-generated graphics chart involves adding, inserting, deleting, and/or moving shapes in response to user-entered commands. We have found that it is also beneficial to automatically reorder and reposition shapes and to edit lines in the chart in conjunction with the execution of those commands in order to maintain the symmetry, continuity, and visual logic of the graphics chart without requiring further user actions. In this regard, the reordering and repositioning of shapes and the editing of lines are self-initiated actions of a graphics process and/or a graphics processor that are not themselves literally required by user actions or user commands. In this sense, these actions are automatic.

According to this specification a graphics process generates and edits a graphics chart in response to received commands. The process may receive commands to ADD, DELETE, and/or MOVE objects in the chart. The graphics chart includes objects such as, for example, shapes and lines. When executing a received editing command, the graphics process performs automatic acts in addition to the literal editing act required by the command. Preferably, the graphics process designates an object in a graphics chart as active, or otherwise places the object in active status. Preferably, the graphics process executes the literal act of an editing command, and automatic acts which may accompany the literal act, with respect to the active object. An object may be placed in active status by the graphics processor according to a rule set. In this regard, when the graphics process places an object such as a shape in active status when performing an ADD, DELETE, or MOVE operation, it performs a self-initiated action that is not literally required by a user action. In this sense, this action is automatic. The graphics process also has the ability to place an object in active status in response to user commands.

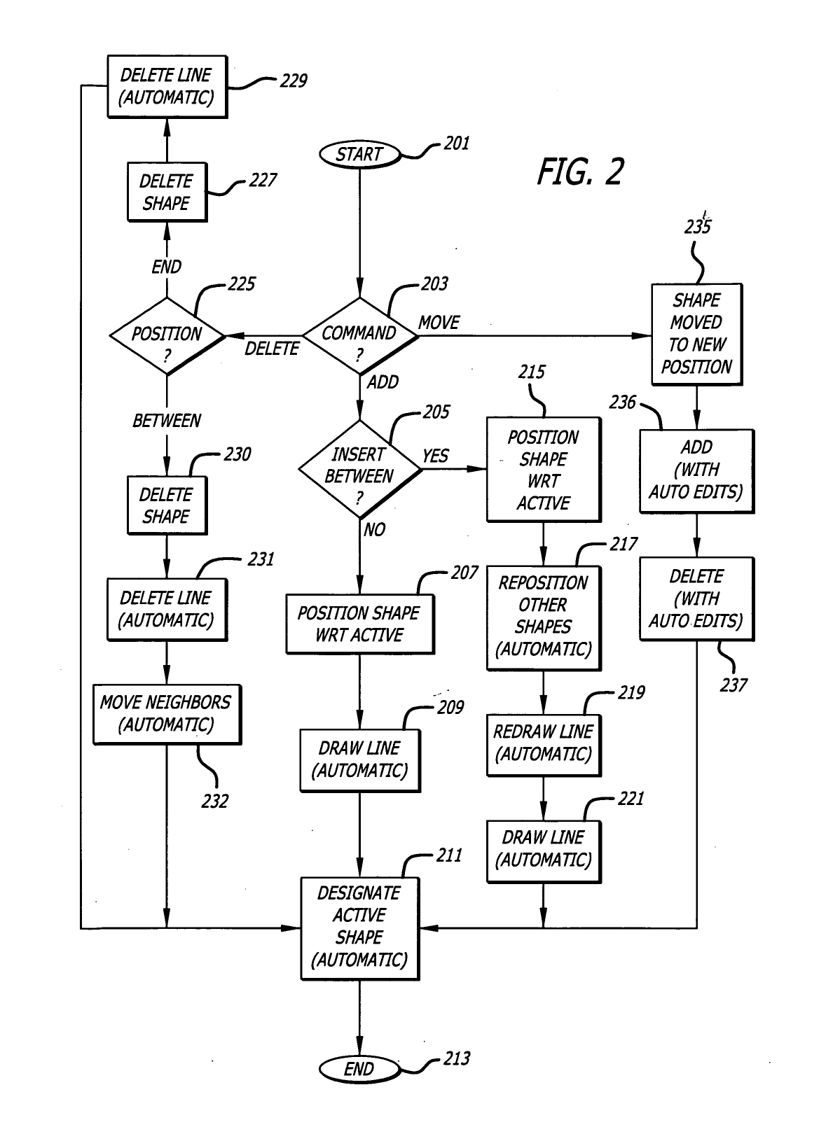

A graphics process with provision for automatically editing a graphics chart is illustrated by the flow chart of FIG. 2. In FIG. 2, a command for editing a graphics chart is received by a graphics process at 201. The command is tested at 203. If the command is one to add a shape to the graphics chart, the process transitions to 205, where the command is tested to determine whether the shape is to be inserted between the active shape and another shape adjacent, and connected by a line, to the active shape. If not, the process transitions to 207, where the added shape is positioned with respect to the active shape. At 209, a line is automatically drawn between the active shape and the added shape. The process designates the active shape in the graphics chart at 211 and completes at 213. If the test at 205 indicates that the added shape is to be positioned between the active shape and a shape in the graphics chart that is adjacent, and connected by a line, to the active shape, the process transitions to 215, positioning the added shape with respect to the active shape, automatically repositioning the adjacent shape away from the active and added shapes, and, if necessary automatically repositioning other shapes and lines in the graphics chart. At 219, the graphics process automatically draws a line between the active shape and the added shape, and at 221 automatically draws a line between the added shape and the adjacent shape that was repositioned to make way for the added shape. The graphics process automatically designates the active shape at 211, and ends at 213.

In FIG. 2, if the test at 203 indicates receipt of a command to delete a shape, the location of the shape is tested at 225 to determine if it occupies an end position in a string of shapes connected by lines. The end position may be indicated by connection of the shape to be deleted to only one other shape. If the shape occupies an end position, the shape is deleted at 227 and the line connecting it to the other shape is automatically deleted at 229. The graphics process automatically designates the active shape at 211, and ends at 213. If the test at 225 indicates that the shape to be deleted is not located at an end position, the graphics process transitions to 230, deletes the shape, and then automatically repositions an adjacent shape to which the deleted shape was connected into the position formerly occupied by the deleted shape and automatically repositions other shapes and redraws lines as needed to maintain symmetry, connectivity, and visual logic in the graphics chart. The graphics process then automatically designates the active shape at 211, and ends at 213.

In FIG. 2, if the test at 203 indicates receipt of a command to move a shape in the graphics chart from one position to another, the graphics process determines the new position at 235 and conducts move processing. The move process is constituted of add processing 236, with automatic editing as required, to add the shape at the location to which it is moved, followed by delete processing 237, with automatic editing as required, to delete the shape at the location from which it is moved. The graphics process then automatically designates the active shape at 211, and ends at 213.

Operations performed by a graphics process constructed according to FIG. 2 are illustrated by examples shown in FIG. 3, where a graphics chart 310 produced by a graphics process is initiated by selection of a shape 311 that represents the start of a flow chart. When the graphics chart 310 is initiated, the start shape 311 is designated as the active object.

Following initiation, a selected object may be added to the graphics chart 310 by an ADD command. The ADD command places the selected object into the graphics chart in reference to the active object. Thus, the ADD command may have the form ADD DIRECTION, with direction referring to a direction in the chart from the active object. For example, direction may be given by a member of the group (top, right, bottom, left). In the example of FIG. 3, the flow chart is edited by addition of a box 312 below the start shape 311. Preferably, an object is added to the chart by selecting a shape to be added and indicating by the ADD command where the selected shape is to be added with respect to the active object. Presume selection of a box shape and receipt of a command (ADD BELOW) to add it below the start shape 311. The command is executed by the graphics process, which places the box 312 below the start shape 311. When adding the box 312 to the graphics chart 310 in response to a user-entered command, the graphics process also executes self-initiated editing steps to maintain symmetry, continuity, and visual logic of the objects in the chart. Such automatic steps include drawing the line 314 originating on the lower edge of the start shape 311 and ending on the upper edge of the box 312 with the arrowhead 315 pointing to the added shape 312. The editing command routine also includes automatic rule-based placement of a shape in active status for the next command. For example, the added shape, the box 312, may be automatically placed in active status or otherwise automatically designated as the active object by the graphics process.

Receipt of shape selection and an ADD BELOW command cause another shape, the diamond 317, to be added to the graphics chart, below the active object (the shape 312), where adding the diamond 317 is accompanied by the self-initiated, or automatic steps of drawing the line 319 from the active object (the box 312) to the added shape (the diamond 317). The editing command routine also includes automatic rule-based placement of a shape in active status for the next command. For example, the added shape, the diamond 317, may be automatically placed in active status or otherwise automatically designated as the active object by the graphics process.

An object may be moved in the graphics chart 310 by a drag-and-drop process initiated by operation of a mouse. Presume that the diamond shape 317 in FIG. 3 is the active object. Mouse commands drag the diamond shape 317 to the line 314 and drop it there. The drag-and-drop process commands the graphics process to move the diamond shape 317 from its position below the box 312 to another position between the start shape 311 and the box 312. When moving the diamond shape 317 to a location on the line 314 in response to a user-entered command, the graphics process also executes self-initiated editing steps to maintain symmetry, continuity, and visual logic of the objects in the chart. Such automatic steps include deleting the line 319, repositioning the box 312 below the diamond shape 317, drawing the line 321 between the moved diamond shape and the box 312, with the orientation shown, and adjusting the length of the line 314 to equal that of the line 321. The editing command routine also includes automatic rule-based placement of a shape in active status for the next command. For example, the repositioned box 312 may be automatically placed in active status or otherwise automatically designated as the active object by the graphics process.

Deletion of a shape from the graphics chart 310 is accomplished with a DELETE command. Presume that the diamond shape is the active object and that a command to delete it is received. Per FIG. 3, the diamond shape 317 is removed from the graphics chart 310. When deleting the diamond shape 317 from the graphics chart 310 in response to a user-entered command, the graphics process also executes self-initiated editing steps to maintain symmetry, continuity, and visual logic of the objects in the chart. Such automatic steps include deleting the line 321 and repositioning the box 312 to the position below the start shape 311 that was held by the deleted diamond shape. The editing command routine also includes automatic rule-based placement of a shape in active status for the next command. For example, one of the shapes from between which the diamond was deleted may be automatically placed in active status or otherwise automatically designated as the active object by the graphics process.

Insertion of a selected shape into the graphics chart 310 between connected shapes already in the chart is accomplished with an ADD command. Presume that the diamond shape has been deleted and the box 312 is the active object. A command to add a rounded rectangle above (ADD ABOVE) the box 312 is received. Per FIG. 3, the rounded rectangle 323 is inserted into the graphics chart 310 at the location of the box 312. When inserting the rounded rectangle 323 into the graphics chart 310 in response to a user-entered command, the graphics process also executes self-initiated editing steps to maintain symmetry, continuity, and visual logic of the objects in the chart. Such automatic steps include maintaining the line 314 in its present orientation, adding the line 325, and repositioning the box 312 to the position below the rounded rectangle 323. Note that the same result could be produced if the start shape 311 is the active object and a command to add a rounded rectangle below (ADD BELOW) is received. The editing command routine also includes rule-based designation of a shape as active for the next command. For example, the inserted rounded rectangle 323 may be designated as the active object.

A mechanism for automating the editing of a graphics chart may be understood with reference to data objects and rules, with the understanding that the mechanism is merely illustrative and is not intended to limit the application of automatic editing using other mechanisms. Preferably, a mechanism for automatically editing graphics charts is integrated with, or called during, routines the graphics process uses to execute edit commands.

Using a flow chart as an example, the objects may be represented by a list of data records which may also be called “objects”. This list and other lists to be described are maintained and used by the graphics process to perform the automatic actions that accompany its execution of edit commands. A computer- or processor-generated image of the flow chart may be displayed to the screen by walking this list and drawing an image (shape or line) for each of the objects using rules defined by the values in the object's data record. Hence each shape and line in an image of a graphics chart may have a corresponding object record. For example, consider:

| | |
|---|---|
| Object List | |
| { | |
| Object 1 | [Drawn as a blue rectangle at a known position] |
| Object 2 | [Drawn as red triangle at a known position] |
| ....... | [etc.] |
| } | |

In this regard, presume that the automatic editing features include:
1. Shapes that are automatically aligned and spaced, and connected by lines;
2. Adaptation of the positions of shapes in a graphics chart when a shape is inserted into or deleted from the chart; and,
3. Opening up space in the graphics chart for an inserted shape or eliminating the space of a deleted object.

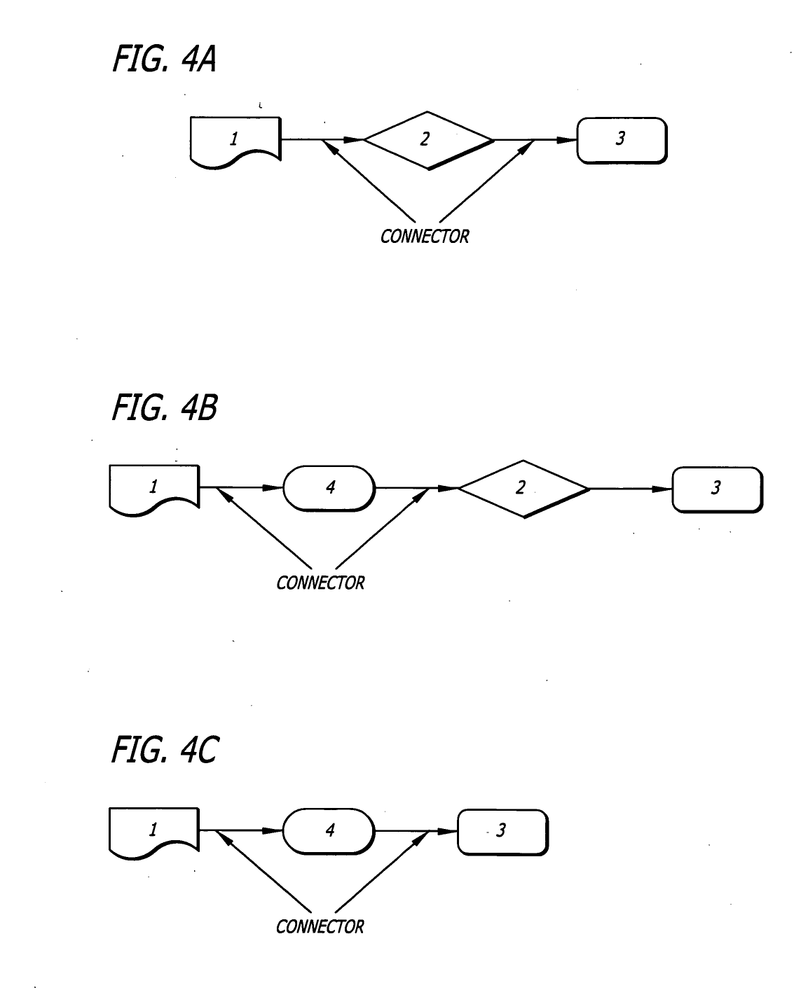

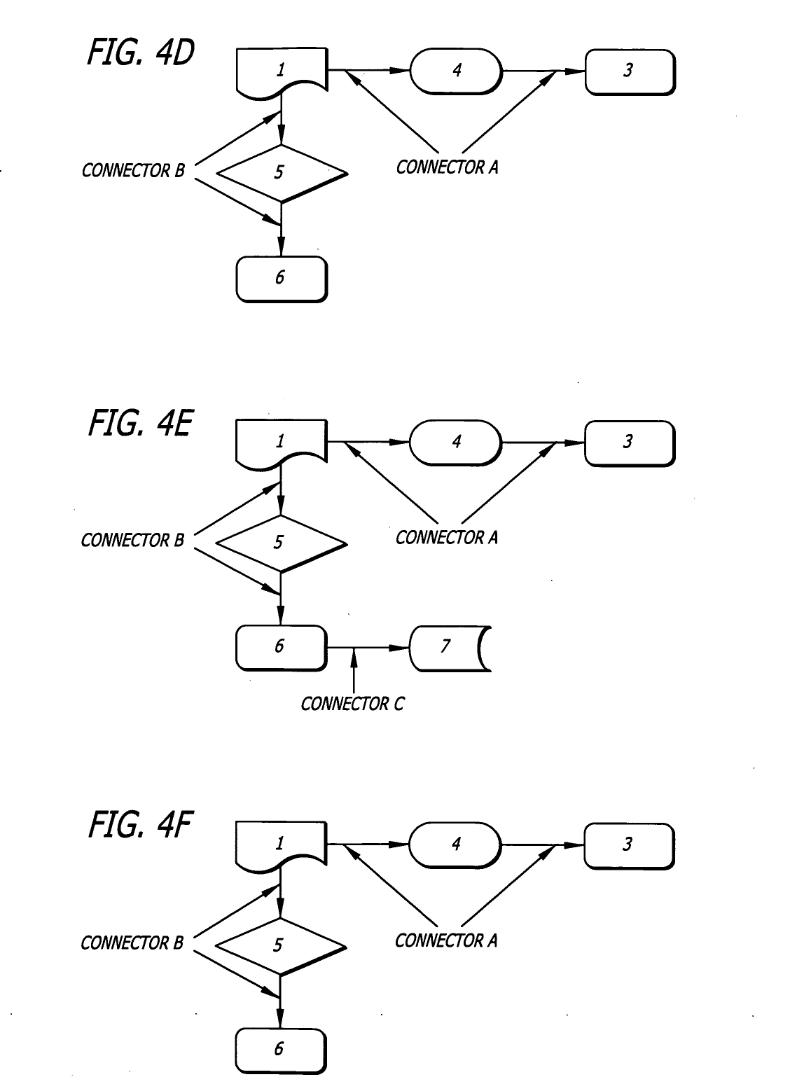

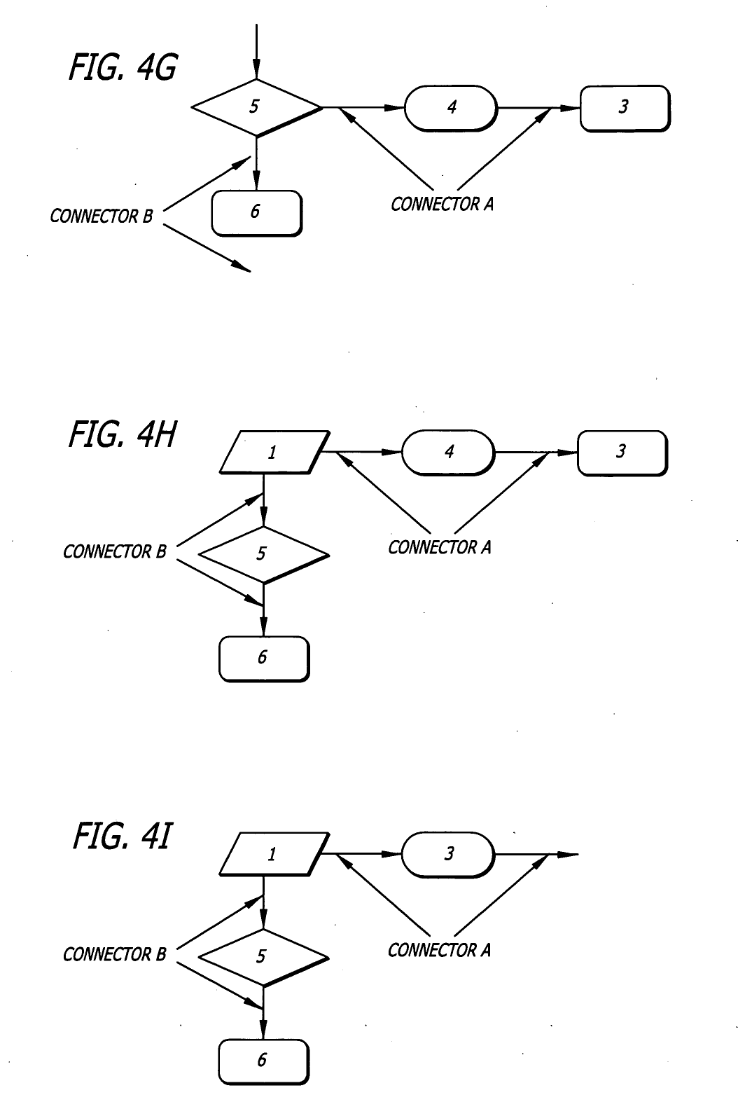

In this example, with reference to FIG. 4A, the behavior of the automatic editing feature may be controlled by an object called a “connector” having the following functions:
1. Connectors draw the lines and arrowheads between shapes; and,
2. Connectors control the position of other objects (shapes) to create the order, spacing and alignment of shapes in a flowchart.

The object record of a connector maintains a list of shapes that are associated with the connector. For example, the shapes may be “slaves” that are controlled by the connector as master. When the connector moves, its slave shapes also move to maintain their relative positions. When a new shape is inserted into this list, the positions of the other shapes are shifted right (or down). When one is removed, they shift left. Connectors can be horizontal or vertical and their slave shapes move side to side or up and down as they are added and removed. The object record of a connector thus also contains information for drawing the connector, which may include the origin and end locations and the orientation (vertical or horizontal) of the connector. In this regard, the origin and end locations implicitly define the length of the connector. With origin, length, and orientation, the graphics process is enabled to draw the connector with its sequence of objects.

Preferably, the graphics process establishes or a connector object record with the following form:

```
Connector Object Record
    {
    Origin and end locations
    Orientation: horizontal/vertical
    Spacing between each shape
    Number of slave shapes
    List of slave shape identifiers [1,2,3...]
    }
```

As per FIG. 4A, presume that a connector has three slave shapes with identifiers [1,2,3]. Inserting a new shape (4) after shape 1 changes the identifiers to [1,4,2,3] and changes the image per FIG. 4B. Now, deleting shape 2 results in an identifier list [1,4,3] and the image in FIG. 4C. In each case, the connector object moves the shapes in the drawings and draws the line segments and arrowheads between the shapes.

In some instances, a connector may be a slave of another object. For example, consider FIG. 4C in which all three shapes are peers and slaves to the master connector. Adding shapes 5 & 6 below shape 1, creates the arrangement shown in FIG. 4D. In FIG. 4D, a second connector B is created that is vertical. Shapes 5 and 6 are slaves of connector B but shape 1 is its master: If Shape 1 moves, connector B follows it and hence shapes 5 and 6 follow it also. The full hierarchy is Connector A, Shape 1, Connector B, Shapes 5 and 6.

With reference to FIGS. 4D and 4E, if a new shape is added to the right of shape 6, a new connector C is added as a slave of shape 6, and the new shape 7 is added as the slave of connector C, and so on in a fully recursive manner.

Although the connectors of this example are described with particular orientations, it should be clear that master and slave connectors may be differently oriented.

A set of rules governs the operation of the automatic editing mechanism. Among these rules are rules for adding shapes and deleting shapes. The rules for adding shapes apply to ADD and MOVE commands.

A first rule governs the addition of a shape to an exiting connector in the orientation of the existing connector. In this regard, if a shape is added next to an existing shape that is already a slave of a master connector in the same orientation as the connector the new shape is added as another in the list that is managed by the connector. If the shape added is the rightmost for a horizontal connector, or bottommost for a vertical connector, the shape's identifier is appended to the list managed for the connector. For example if a connector's list is [1,2,3] and shape 4 is added to the right of shape 3, the list becomes [1,2,3,4]. If the shape added is not rightmost or bottommost, its identifier is inserted into the list at the position that corresponds to the shape's position in the sequence of slave shapes. For example, the list for the connector in FIG. 4A is [1,2,3]. When shape 4 is added to the right of shape 3 as per FIG. 4B, the list becomes [1,4,2,3].

A second rule governs the addition of a shape perpendicular to an existing connector. In this regard, if a shape is added next to an existing shape that is already a slave of a master connector in an orientation that is perpendicular to the master connector, then: 1. a new connector is created in the new direction; 2. the new connector is attached as a slave to the existing shape; and 3. the new shape is attached to the new connector as a slave. A new connector is created for each of the two perpendicular directions possible: up/down for a horizontal connector, and left/right for a vertical one.

A third rule governs the deletion of a shape from a connector. In this regard, if a shape is deleted, the following sequence is applied:

1. As per FIGS. 4F and 4G, If the shape (1) is the master of a slave connector (B), the first slave shape (5) of that connector takes the place of the deleted shape. If there are other shapes that are slaves of B, shape 5 is promoted to master of B connector and replaces the deleted shape as a slave in its master connector (A) shape list. If there are no more shapes that are slaves of B, B is deleted too; or,
2. if the shape is the master of two slave connectors, shapes from the rightmost or bottommost take the place of the deleted shape first; or,
3. as per FIGS. 4H and 4I, if the shape has no slave connectors, it is removed from its master connectors list of slaves and the shapes to its right (or bottom) move to the left (or top).

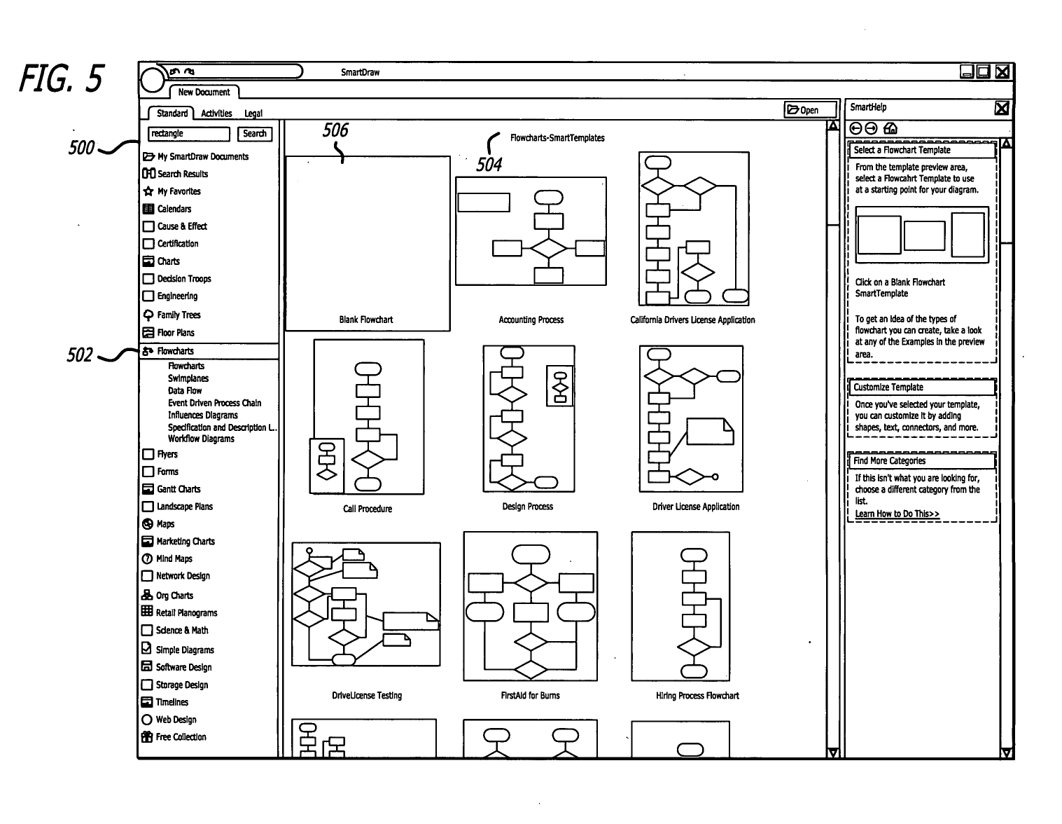

The simplification and added convenience of graphics chart creation realized by automatic editing thus far described may be enhanced by provision of simplified user interfaces for a graphics process. In this regard, FIG. 5 represents an interactive user interface screen which may be displayed in the computer system of FIG. 1, for example. When the interface is initiated, a menu panel 500 on the left edge of the screen may be displayed. The menu 500 lists routines in a graphics process for drawing a variety of graphics charts. Menu items may be selected conventionally by cursor movement and mouse click or keystroke. Selection of a graphics chart routine prompts the graphics process to establish an interactive interface customized for drawing a specific graphics chart. The interface includes a display window including an active drawing area in which the selected kind of chart is drawn and edited and visible menus and icons designed for editing a selected graphics chart. The interface also includes programmed configuration of command and function keys on a keyboard (not shown) to edit and navigate through the graphics chart being drawn. The interface also includes programmed configuration of the pointing device to edit and navigate through the graphics chart being drawn.

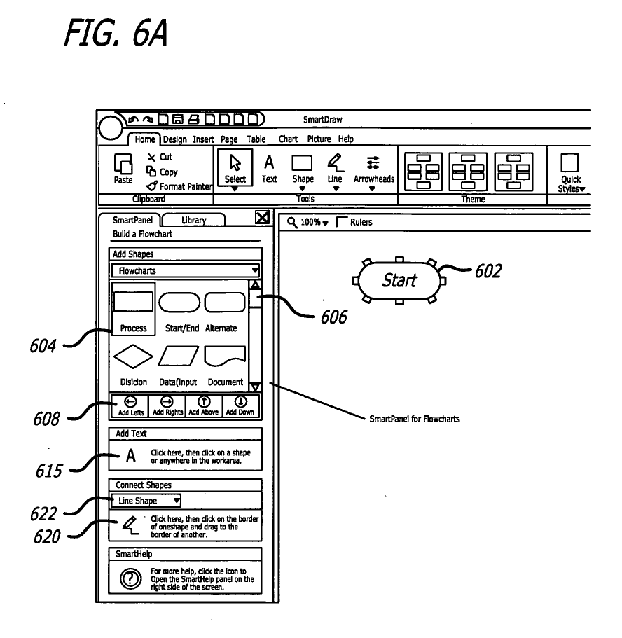

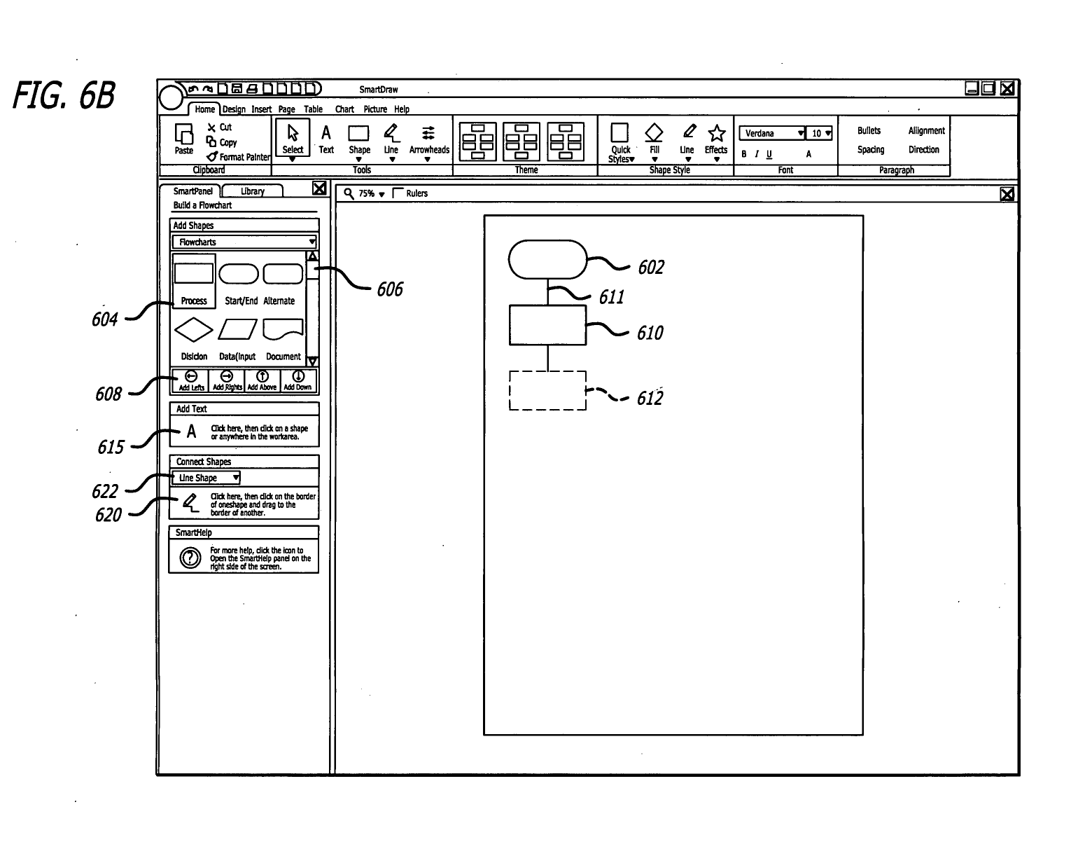

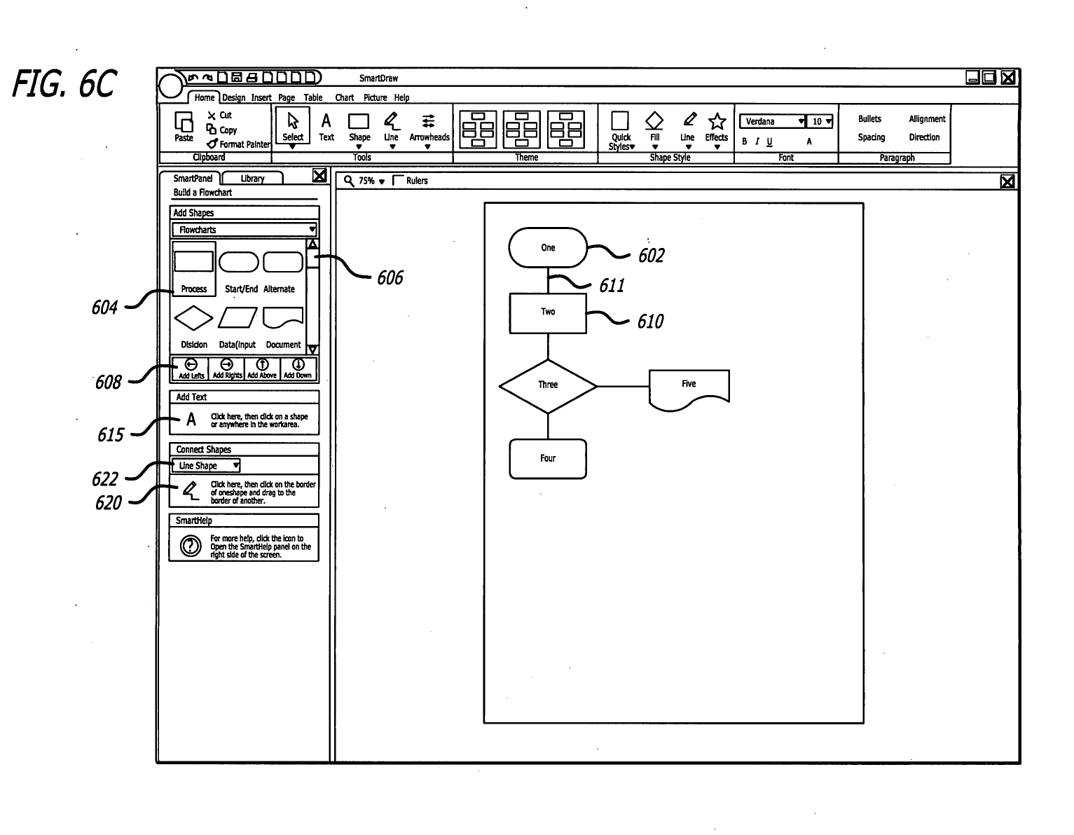

For example, in FIG. 5, a flow chart drawing routine 502 has been selected, opening a submenu that lists graphics charts based on a flow metaphor. An active area 504 displays icons for selection of various flow chart templates. An icon 506 for a blank flow chart is included. A flow chart template may be selected conventionally by cursor movement and mouse click or keystroke. Selection of the blank flow chart icon results in the interface shown in FIGS. 6A and 6B.

As per FIG. 6A, the interface window is customized for drawing a flow chart from scratch. In this regard, a start shape 602 is displayed and designated as active (as indicated by the bounding box) and the menu panel 500 now has four subpanels adapted for drawing a flow chart. In this regard, the subpanel 604 provides a scrolled menu 606 of shape icons corresponding to standard shapes that are typically or widely used in flow charts. A row 608 of buttons in the user interface provides an edit command panel in which each button represents an ADD:DIRECTION command. The user is enabled thereby to select a shape by pointing to and clicking on an icon in the menu 606, and to add the shape to the graphics chart by pointing to and clicking on a button in the row 608. Thus, for example, the selection of the process shape and the ADD:BELOW command in FIG. 6A will produce a result seen in FIG. 6B, where the process shape 610 is added to the graphics chart below the start shape 602, with a line 611 automatically drawn from the start to the process shape.

With the user interface of FIGS. 5, 6A, and 6B thus established, an active object may be visibly distinguished from other objects in the chart by some distinct feature such as a bounding box, highlighting, or any equivalent or corresponding indication. For example, in FIG. 6B the bounding box indicates that the process shape 610 is active. Active status may be conferred by the graphics process according to a rule set applied during execution of an editing step, or by user commands. For example, cursor placement in response to keystrokes and/or mouse/button operation may be used to designate an active object. Thus, in FIG. 6B, the active status of the process shape 610 could have been set automatically by graphics process action, or by user action including point/click action using a mouse or keystroke control, for example, through the tab keys or the set of four direction keys on a standard QWERTY keyboard.

Further keystroke control of graphics chart editing may be provided by way of the Enter key of a standard QWERTY keyboard. In this regard, another process shape 612 may be added to the flow chart of FIG. 6B by use of the menu 606 and button row 608 as described. To add the process shape 612 this way, the graphics process retains the last ADD command by which the process shape 610 was entered so that the command can be repeated by an Enter keystroke. Receipt of an Enter keystroke will cause the graphics process to repeat an immediately preceding add command with reference to the active shape. Thus, in the example of FIG. 6B receipt of an Enter keystroke would repeat the ADD:BELOW command that added the the process shape 610, resulting in addition of a process shape 612 below the process shape 610, with a line pointing from the previous to the added process shape and designation of the added process shape as active. In the case of the Enter keystroke used in this manner, both the drawing of an added shape and the drawing of a line from the active to the added shape are automatic edits of a graphics chart.

Further keystroke control of graphics chart editing may be provided by way of the Delete key of a standard QWERTY keyboard. In this regard, presume that the process shape 612 has been added to the flow chart of FIG. 6B by use of the menu 606 and button row 608, or by an Enter keystroke as described. Either of the shapes 610, 612 may be deleted by designation of the shape as active and entry of a Delete keystroke. Further, once a shape is deleted, with automatic editing, the graphics process designates an immediately adjoining shape as the active shape. Thus, the delete process may be iterated through a series, sequence, or set of connected shapes by successively tapping the Delete key. For example, presume the process shape 612 is designated as active. Receipt of a Delete keystroke will result in deletion of the process shape 612, automatic deletion of the line connecting the process shapes 610, 612, and automatic rule-based placement of the process shape 610 in active status. Receipt of a following Delete keystroke will result in deletion of the process shape 610 and the line 611, and so on.

The user interface represented by FIG. 5 and FIGS. 6A-6C may support navigation through a graphics chart by keystrokes. For example, with the active shape as a starting location, the graphics process responds to a keystroke from any one of the four direction keys of a standard QWERTY keyboard by moving the active designation and visible indication to the adjacent shape in the direction indicated by the received keystroke. Alternatively, the graphics process may navigate from an active shape through a graphics chart in response to tab keystrokes from a QWERTY keyboard. In either case, in FIG. 6C, the graphics process provides navigation up and down the sequence of shapes one, two, three, four, and across the sequence of shapes three, five, with or without wrapping between end shapes in response to keystrokes. Such navigation is useful, for example, for re-designating the active object.

The user interface represented by FIGS. 5 and 6A-6C supports annotation of a graphics chart. For example, the graphics process may receive a command to enter text into a shape, wherein the command is generated by clicking the second subpanel 615 and then a shape in the graphics chart. This would designate the clicked shape as active and permit entry of alphanumeric and special characters using corresponding keys of a standard QWERTY keyboard. The annotation function would be deselected by again clicking the second subpanel 615.

The user interface represented by FIGS. 5 and 6A-6C supports commands to enter line shapes into the graphics chart by user issued-command via the subpanel 620 and pull-down menu 622. For example, the graphics process may receive a command to enter a shape by clicking the desired shape in the pull-down menu 622, then clicking the border of one shape in the graphics char. This attaches the origin of the line to the clicked border and adds the line to the graphics chart. The end of the line in the graphics chart is then dragged to the border of another shape in the graphics chart. The added line is treated as an object of the graphics chart.

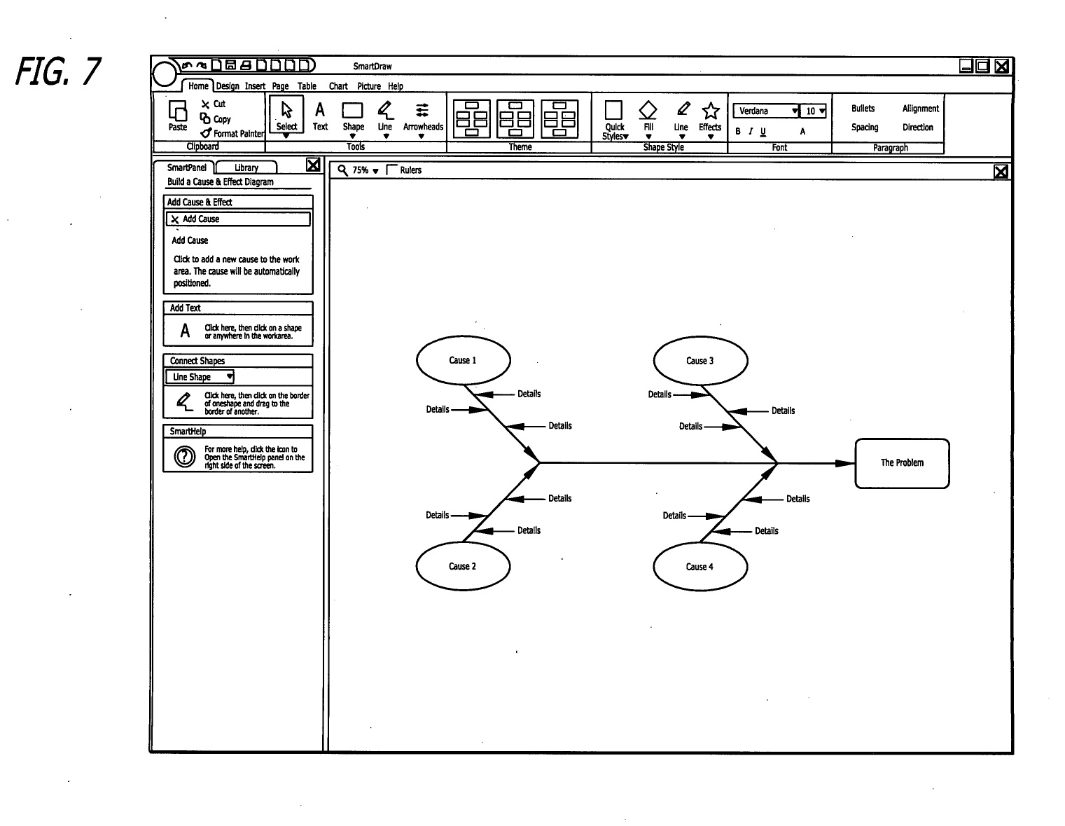

It should be evident that the mechanism and rules set out in the flow chart example may be extended to or adapted for editing other graphics charts whose objects include shapes and lines and whose format rules connect objects in different ways than flow charts. For example, objects may be added, moved, and deleted in the cause and effect diagram of FIG. 7 with automatic editing. In this regard, the objects may include shapes, lines, and details, and automatic editing may include repositioning of shapes and lines when shapes or details are added or deleted, drawing of lines connecting added shapes or details to the diagram, and deletion of lines associated with deleted shapes and details. The object records, master-slave relationships, and rules described above are easily adapted for these tasks, and the perpendicular relationship of connectors may be conventionally altered for the non-orthogonal intersections in the graphics chart of FIG. 7.

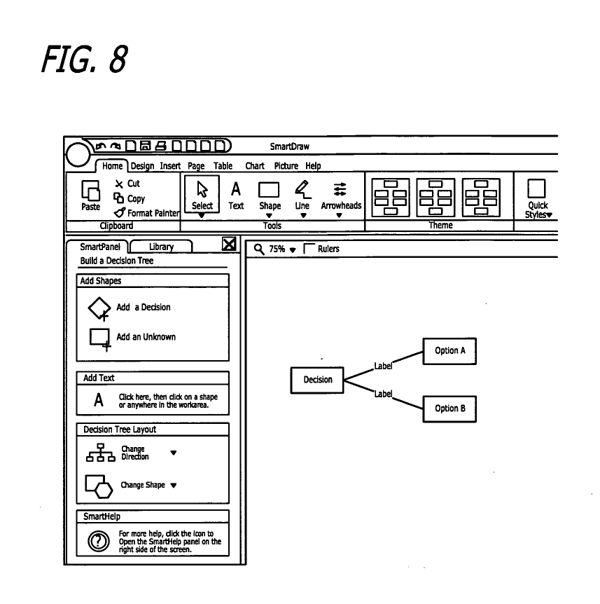

Similarly, the mechanism and rules for the flow chart example may be extended to or adapted for automatically editing decision trees such as that illustrated in FIG. 8, where the objects are shapes and lines and the format rules include two lines diverging at an acute angle from a test shape (a circle). Objects may be added, moved, and deleted in the decision tree diagram of FIG. 8 with automatic editing. In this regard, the objects may include shapes and lines, and automatic editing may include repositioning of shapes and lines when shapes are added or deleted, drawing diverging lines extending out of added test shapes and straight lines out of added decision shapes (squares) diagram. Automatic editing may also include deletion of lines associated with deleted shapes. The object records, master-slave relationships, and rules described above are easily adapted for these tasks, and the perpendicular relationship of connectors may be conventionally altered for the acute divergences in the graphics chart of FIG. 8.

The scope of patent protection afforded the novel graphics process and graphics processor described and illustrated herein may suitably comprise, consist of, or consist essentially of the elements described. Further, the novel graphics process and graphics processor disclosed and illustrated herein may suitably be practiced in the absence of any element or step which is not specifically disclosed in the specification, illustrated in the drawings, and/or exemplified in the embodiments of this application.

Moreover, although an invention has been described with reference to particular embodiments, it should be understood that various modifications can be made without departing from the spirit of the invention. Accordingly, the invention is limited only by the following claims.

1. A computer-executed method for editing a graphics chart, comprising:
receiving a selection of an object;
receiving a command to add the selected object to a computer-generated graphics chart in a direction referenced to another object in the graphics chart;
adding the selected object to the graphics chart in the direction; and,
automatically drawing a line in the graphics chart between the other object and the selected object.

2. The computer-executed method of claim 1, further comprising:
designating an object in the graphics chart;
receiving a command to delete the designated object; and,
deleting the designated object.

3. The computer-executed method of claim 2, further comprising:
automatically moving an object adjacent to the designated object to the location of the designated object in the graphics chart when the designated object is deleted.

4. The computer-executed method of claim 2, further comprising:
automatically removing a line between the designated object and an object adjacent to the designated object in the graphics chart when the designated object is deleted.

5. The computer-executed method of claim 3, wherein the graphics chart is selected from the group including flow chart, cause and effect diagram, decision tree, mind map, Gantt chart, device model, and system model.

6. The computer-executed method of claim 4, wherein the graphics chart is selected from the group including flow chart, cause and effect diagram, decision tree, mind map, Gantt chart, device model, and system model.

7. The computer-executed method of claim 3, wherein the commands to add and delete are keystroke commands.

8. The computer-executed method of claim 4, wherein the commands to add and delete are keystroke commands.

9. The computer-executed method of claim 1, further comprising:
moving an object in the graphics chart by dragging and dropping the object.

10. A computer-executed method for editing a graphics chart, comprising:
placing a first object in the graphics chart in an active status;
receiving a Delete keystroke;
deleting the first object in response to the active status and the Delete keystroke;
automatically moving a second object adjacent and connected to the first object to the location of the first object in the graphics chart;
automatically removing a line between the first and second objects; and
automatically placing the second object in the active status.

11. The computer-executed method of claim 10, further comprising:
receiving a Delete keystroke;
deleting the second object in response to the active status and the Delete keystroke;

12. The computer-executed method of claim 11, wherein the graphics chart is selected from the group including flow chart, cause and effect diagram, decision tree, mind map, Gantt chart, device model, and system model.

13. A computer-executed method for generating a graphics chart, comprising:
establishing an object connector;
maintaining a list of shapes associated with the object connector; and,
with the connector, drawing the shapes and line segments connecting the shapes in the graphics chart.

14. The computer-executed method of claim 13, wherein the object connector has a direction with respect to the graphics chart, and drawing the shapes and line segments includes drawing in the direction of the connector.

15. The computer-executed method of claim 13, further comprising:
receiving a command to add a shape associated with the object connector to the graphics chart;
adding the shape to the list of shapes; and,
with the connector, drawing the shapes, with the added shape, and line segments connecting the shapes and the added shape in the graphics chart.

16. The computer-executed method of claim 15, wherein:
maintaining the list of shapes includes maintaining an order of the shapes;
and, drawing the shapes includes drawing the shapes in the order.

17. The computer-executed method of claim 16, wherein the object connector has a direction with respect to the graphics chart, and drawing the shapes and line segments includes drawing in the direction of the connector.

18. The computer-executed method of claim 13, further comprising:
receiving a command to delete a shape associated with the object connector to the graphics chart;
deleting the shape from the list of shapes; and,
with the connector, drawing the shapes, without the added shape, and line segments connecting the shapes without the deleted shape in the graphics chart.

19. The computer-executed method of claim 18, wherein:
maintaining the list of shapes includes maintaining an order of the shapes;
and, drawing the shapes includes drawing the shapes in the order.

20. The computer-executed method of claim 19, wherein the object connector has a direction with respect to the graphics chart, and drawing the shapes and line segments includes drawing in the direction of the connector.

21. A computer-executed method of operating a computer-generated user interface on an output screen for drawing graphics charts, comprising:
causing display of a menu panel on the output screen;
the menu listing routines in a graphics process for drawing a plurality of types of graphics charts;
receiving selection of a routine listed in the menu for drawing a selected type of graphics chart listed; and,
establishing an interactive interface customized for drawing the selected type of graphics chart;
the interface including a display window including:
a screen area for drawing the selected type of graphics chart;
at least one template in the screen area for the selected type of graphics chart; and,
one or more menu panels with means for editing and means for annotating the selected type of graphics chart.

22. The computer-executed method of claim 21, the interface further including:
programmed configuration of command and function keys on a keyboard to edit and navigate through the selected type of graphics chart; and,
programmed configuration of a pointing device to edit and navigate through the selected type of graphics chart.

23. The computer-executed method of claim 22, further comprising adding an object to the selected type of graphics chart and automatically editing the selected type of graphics chart when the object is added.

24. The computer-executed method of claim 23, the selected type of graphics chart being selected from the group including flow chart, cause and effect diagram, decision tree, mind map, Gantt chart, device model, and system model.
